(19) United States
(12) Patent Application Publication
(10) Pub. No.: US 2008/0108914 A1
(43) Pub. Date: May 8, 2008

(54) Low Frequency Lung Vibration and Sputum Removal Apparatus

(76) Inventors: Laurent Brouqueyre, Kennesaw, GA (US); Gary W. Caille, Roswell, GA (US); Peter H. Rogers, Atlanta, GA (US)

Correspondence Address: Peter H. Rogers, 750 Park Avenue, Apartment 19N, Atlanta, GA, 30326, US

(21) Appl. No.: 11/556,302

(22) Filed: Nov. 3, 2006

(51) Int. Cl. A61H 23/00

(52) U.S. Cl. 601/2; 601/15

(57) ABSTRACT

A low-frequency lung vibration apparatus is designed to vibrate lungs clogged by sputum, using acoustic waves. The freed sputum becomes easier to be removed by expectoration. The apparatus includes a garment composed of layers, a plurality of electro-mechanical or dynamic vibrators and a controlling unit. An inner layer contains a loading and shape conforming material, while an outer shell holds the vibrators, the controller and the inner garment together. An outer shell is made of a non-stretch material. Several fasteners/zippers hold the inner garment in place and several strategically placed straps allow a tight fit of the garment. The loading created by the layers of the apparatus is tailored to cause the existence of a uniform compression-expansion resonance of the lungs beneficial for sputum removal. A controlling unit allows the detection of a person's lungs resonance frequency and controls the vibrator(s) frequency and amplitude during a treatment.

### PARENT CASE TEXT

This non-provisional patent application is a continuation of provisional patent application Ser. No. 67/733,285 filed on Nov. 3, 2005.

### TECHNICAL FIELD

The present invention relates generally to therapeutic treatments for medical patients, and, more particularly, to an apparatus for causing the mobilization of respiratory secretions through the acoustic excitation of the lungs at or near their compression and expansion resonance frequency. This acoustic excitation and resulting vibration helps to dislodge, loosen and expectorate the sputum from the lungs of a person.

### BACKGROUND OF THE INVENTION

Cystic Fibrosis (CF) is a recessive genetic disease caused by mutations in a membrane-associated protein, which promotes transcellular movement of chloride ions in airway epithelia and other tissues. In the lungs, defective function of the membrane-associated protein results in abnormally thick secretions in the lower airways which plug small bronchioles and provide an environment for chronic endobronchincal bacterial infection. Despite recruitment of vast numbers of neutrophils, bacterial clearance is ineffective, and the airways of the lungs are damaged by free radical species and prostheses released by the neutrophils. In addition, as the recruited neutrophils decompose in the airway, the DNA from their nuclei markedly increase the viscosity of the lower airway secretions, leading to further airway blockage and infection. The end result of this above-identified cycle is destruction of bronchial airway structure and progressive loss of lung function in the CF patient. Despite significant improvements in clinical management, respiratory failure and related pulmonary complications account for over ninety percent of CF mortality.

Since pulmonary disease is the primary cause of morbidity and mortality in CF, considerable effort has been directed to increase the mobilization of the abnormally thick airway secretions through various forms of chest physiotherapy. In the normal respiratory system, there are three primary mucus transport mechanisms. First, as is predominate in the smaller airways of the lungs, is a conveyor-like effect of a coordinated beating of airway epthocilia. In the larger airways, the second method of mucus transport is the high velocity airflow associated with coughing. Coughing tends to shear mucus off airway surfaces and propels it towards the pharynx. The third mechanism of transporting mucus through the lungs is termed cephalad airflow bias of tidal breathing. Cephalad airflow bias results from greater expiratory versus inspiratory airflow due to compression of the intrathorasic airways during expiration. However, the abnormal composition and increased amount of tracheal bronchial secretions in the airways of a CF patient impede all of these natural mechanisms of mucus clearance.

For this reason, several forms of chest physiotherapy have been developed. These methods of chest physiotherapy are intended to assist in pulmonary mucus clearance and are presently widely used for CF patients. The mechanism underlying all modes of chest physiotherapy currently in use is vibration of the airway surfaces, either through the external chest compression or by oscillatory airflow, to promote increased cephalad-induced and/or cough-induced mobilization of airway secretions.

Currently, the most common form of chest physiotherapy is manual chest physiotherapy. In manual chest physiotherapy a trained caregiver strikes the patient's chest with cupped hands. This striking motion is usually complimented with postural drainage, a systematic form of directing mucus from the peripheral to the central airways through a series of gravity-assisted patient positions and therapist stimulation. Each physiotherapy session is coupled with a period of huffing and coughing to remove sputum. While this method of therapy is somewhat effective, manual chest physiotherapy is labor intensive and may require the skill of a trained caregiver. For this reason, manual chest physiotherapy may be expensive and/or time consuming for the therapist and patient. Additionally, the striking of the chest may cause discomfort to the patient or damage to a more fragile patient's ribcage.

Various mechanical devices have been developed in an effort to standardize and increase the efficiency of chest physiotherapy. Among the most widely employed forms of mechanical chest physiotherapy are various hand-held compressors which deliver external chest vibration, devices such as a FLUTTER™ device, U.S. Pat. No. 5,018,517 by Liardet, which delivers internal airway stimulation from pulsating airflow via the mouth, and high frequency chest compression administered through an inflatable jacket. These mechanical devices actually compress the external chest wall resulting in physically compressing the ribs, muscles and lungs. These devices typically use air bladders that are inflated and deflated by motor-operated air valves, as described in U.S. Pat. No. 5,056,505 by W. J. Warwick and L. G. Hansen. The external vibration of the chest has also been obtained by various types of electro-magnetic sources, as described in U.S. Pat. No. 5,235,967 by Arbisi and in U.S. Pat. No. 6,193,678 by Brannon.

The high frequency chest compression (HFCC) method of chest physiotherapy is very commonly employed today. HFCC is administered via a product called the VEST™. In clinical studies with CF patients, use of the VEST™ has been shown to be a practical, automated method of chest physiotherapy, and is an improvement over manual therapy to the extent that it allows for increased patient independence. HFCC, via oscillating chest compression, stimulates cough with its associated mucus shearing airflow spikes, and the compression of the thorax during expiration results in increased expiratory airflow. It is hypothesized also that HFCC at certain frequencies promotes a longer ciliary brush stroke, thereby enhancing mucus transport.

The VEST™ device consists of an inflatable vest structure which is strapped onto the patient's torso. The inflatable vest structure is attached by supply tubes to an air compressor. The air compressor is powered such that it can force air into the vest worn by the patient at set frequencies and amplitudes. In this way, the vest that the patient wears is inflated to compress the patient's chest at set frequencies and amplitudes.

With the present mechanical devices such as the VEST™, the oscillating pressure administered to the chest wall is not transmitted equally across the chest to the underlying lung. Increased mucus transport only occurs in those portions of the lungs directly covered by the VEST™. In particular, with the VEST™ device the lungs are excited from the sides but not from the top or bottom. The pressure administered by the VEST™ device is not uniform. The pressures applied to the patient's chest vary greatly. Additionally, the frequency at which the vest operates is not fine-tuned such as to optimize airway stimulation with the least amount of applied external energy. Generally, in clinical use of the VEST™, patients adjust the frequency and amplitude of the applied chest wall oscillation to what they believe provides the best results.

In addition to the above-referenced shortcomings of the prior art chest physiotherapy regimens, the current methods of chest physiotherapy are generally quite uncomfortable. Most of the current methods of chest physiotherapy require a force to be exerted on the external chest cavity of the patient. This is disadvantageous to all patients, but particularly to those who are more prone to rib or chest injury due to the impact, such as frail or elderly patients and very young patients.

Another type of device uses a water-filled bath and sound sources to generate sound waves aimed at dislodging the sputum stored in a person's lungs, as described by Nedwell in U.S. Pat. No. 6,190,337, or by Rogers in U.S. Pat. No. 6,974,425. While a patient is seated in a water-filled bath, the sound generated by the device interacts almost entirely with the lungs, but does not interact with the rest of the body because its acoustic impedance is similar to that of water. The presence of the surrounding water also causes a lung resonance where the lung expands and contracts uniformly at relatively large amplitudes. The drawbacks of this system include its lack of portability and the necessity to submerge the patient in a bulky water filled bath.

Therefore, it would be desirable to have a method and apparatus for chest physiotherapy that does not involve a trained caregiver or physiotherapist, such as to minimize cost, and also involves a marginal, if any amount of impact to the patient's chest. It is also desirable to have a method and apparatus for chest physiotherapy that does not cause discomfort to the patient, applies more uniform stimulation to the lungs and excites the entire lung. Finally it is desirable to have an apparatus which is portable. The invention described in detail below meets the limitations of the prior art.

### SUMMARY OF THE INVENTION

The present invention aims to use the advantages of the previously cited therapies, but to forego their respective drawbacks.

The VEST™ developed by Warwick or Arbisi provides a portable means of self-treatment, which is its main advantage. Therefore our apparatus will be based on a portable unit. However, the treatment methodology offered Warwick or Arbisi is not the most efficient because it does not take into account the actual environment of the lungs and the interaction between the lung and the environment.

Sound and vibrations interact with the lungs much more efficiently if there is no impedance mismatch between the sound propagating media and the chest. This is a key advantage of the patent by Nedwell. Therefore our apparatus includes an inner layer composed of a form fitting material, like a gel or a fluid, which has approximately the same acoustic impedance as a body.

While seated in a water bath described by Nedwell or Rogers, the lungs are loaded by the water that surrounds them. This uniform loading of the lungs is required to be able to excite the lungs in a uniform compression-expansion manner. Therefore our apparatus will include a significant mass of a form fitting material and materials that surround it. The location of the mass loading is designed to compensate for the water-like mass already present in the stomach area of a person and create a uniform loading of a chest. Therefore a t-shirt, a jacket or a turtleneck shape will be favorite embodiments of an apparatus. Depending on the body shape and dimensions of a person, the load required to uniformly load the chest varies between 10 and 40 lbs. With such a load, the lung will have a resonance close both in frequency and mode shape (uniform expansion and compression) to the fundamental resonance observed in submerged divers (“Measurement of the depth dependent resonance of water loaded human lungs” J. S. Martin, P. H. Rogers, and E. A. Cudahy, Journal of the Acoustical Society of America 117. 2291-2300, 2005).

While uniformly loaded, a uniform compression-expansion resonance frequency of the lungs falls between 10 and 100 Hz depending on a person. In order to determine a lung resonance frequency of a person, a calibration is run. A sweep in frequency between 10 and 100 Hz is used in conjunction with a hydrophone, an accelerometer and/or an airflow measurement device. A resonance is determined as a frequency for which the Sound Pressure Level difference between a calibration with a suitable model and a calibration with a person wearing an apparatus is the highest, as measured by a hydrophone or an accelerometer. A resonance can also be defined as a frequency for which the airflow measured out of the nose and mouth of the wearer decreases drastically over a short frequency range.

Once a resonance frequency of a person's lungs has been established, a therapeutic level of treatment is between 150 and 170 dB re 1 μPa measured at the sternal notch. A hydrophone and/or an accelerometer are used during the treatment to monitor the acoustic level surrounding the lungs.

To ensure that the vibration created by the sources propagates mostly towards the chest of a person wearing the apparatus, several stiffened and weight-bearing areas are positioned on the outer shell. These areas are more rigid and denser than the average rigidity and density of the chest.

A treatment session usually lasts 30 minutes. It can be divided in segments of different length and frequency. For example, a treatment regimen could be 30 minutes at the detected resonance frequency. Another regimen could be divided in three sessions. One session lasts 10 minutes below the resonance frequency, 10 minutes at the resonance frequency and 10 minutes above the resonance frequency. The order of each session can be randomized.

The method and apparatus described herein can result in effective treatment of many debilitating ailments. For example, this method and apparatus may prove to be a particularly effective treatment for cystic fibrosis patients, chronic obstructive pulmonary disease, pneumonia, and lung cancer, by way of example.

This method is also an improvement over the prior art for several reasons. First it can be operated such that a lung of a patient moves uniformly for more effective treatment. Second, it creates and exploits a resonance which permits effective excitation with less driving energy and force. Third, this method does not require the presence of a trained caregiver or physical therapist. Finally, it is common to administer drugs to patients, such as cystic fibrosis patients, through airborne inhalants. Experimental evidence suggests that the absorption of air-delivered drugs, if administered during acoustic excitation of the lungs, will increase.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a cut-away front view of an exemplary low frequency lung vibration and sputum apparatus and of a chest according to the present invention.

FIG. 2 is a cut-away side view of the layers composing the low frequency lung vibration and sputum apparatus.

FIG. 3 is a front and back view of the low frequency lung vibration and sputum apparatus

FIG. 4 is an exemplary of the accessories of the low frequency lung vibration and sputum apparatus.

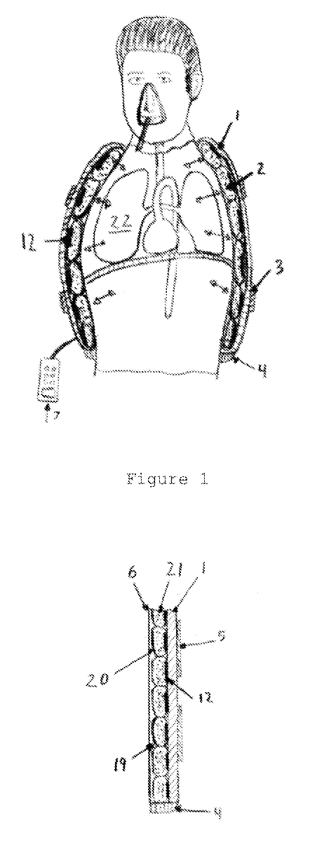

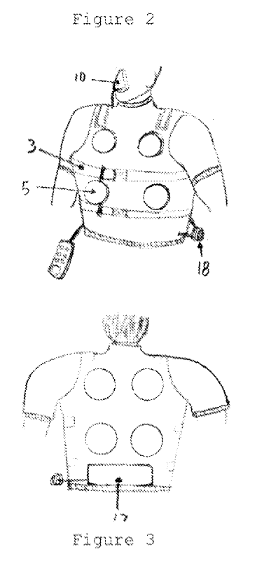

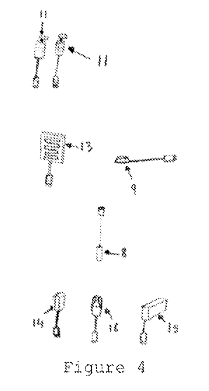

### DETAILED DESCRIPTION OF THE PREFERRED EMBODIMENT

The apparatus can have several overall shapes. A turtleneck, a vest or a jacket can easily be envisioned, as depicted in the accompanying drawings. These drawings represent the unit invented for males. Different units, but based on the same concepts, are also envisioned to fulfill the specific requirements of a female or a child chest.

The excitation of the lungs (22) is obtained by classical electro-mechanic or electro-dynamic vibrators (11), which are commonly known by people in the field. Depending on the physiology of a person, the therapeutic acoustic level and uniformity requirements, more than one vibrator may be used.

Vibrators are located between an outer shell (1) of an apparatus and the chest of a person. They are attached to an apparatus via hook and loop fasteners, such as Velcro®, stitches or glue as commonly done in the field of chest message and vibration. When using hook and loop fasteners, the vibrator(s) can be attached in a most beneficial therapeutic position. An outer shell presents local reinforcements (5) which help with the loading of a chest and the stiffening of an apparatus.

An outer shell of an apparatus allows a tight fit of an inner layer (2) with a person's chest. This fit is obtained by tightening belts or Velcro covered straps (3) attached to an outer shell of an apparatus. A belt (4) is used to tighten an apparatus above a lower part of a person's abdomen.

An inner layer is composed of several enclosures made of washable packaging (20). Each enclosure contains a form fitting material, like a gel or a fluid (21). The quantity and location of a material is adapted to an individual in order to ensure a proper fit and a proper mass loading of a person's lung.

To provide a best fit of an inner layer, a pump (18) is used to fill an inner layer (19) with fluid from a reservoir (17) between an inner layer of an apparatus and the chest of a patient in a waterproof and flexible compartment (6).

An inner layer (19) can be connected to an outer shell with zippers, stitches or hook and loop fasteners (12), depending on the preferred embodiment of an apparatus.

Electric heating elements (13) can be added to an apparatus to help provide relief to a person.

An inner layer (19) can be foreseen as a cooling/heating unit if an inner layer is placed in a warm or cold environment before being worn.

A hand held controller (7) is connected to the vibrators of an apparatus, to a hydrophone (8), a accelerometer (9) and an airflow-meter (10). A hydrophone and an accelerometer are placed above the sternal notch, while the airflow-meter covers the nose and mouth of a person. A controller determines a compression/expansion resonance frequency of the lungs of a person by using inputs from the sensors connected to it. A controller also includes a timing mechanism to monitor the length of a treatment, and amplitude of the excitation.

The invention can be powered by an AC/DC converter (14), a rechargeable battery pack (15) or a vehicle cigarette lighter power adapter (16).

We claim:

1. A lung vibration and sputum removal apparatus comprising:
A vest unit including a flexible inner surface that fits tightly to a wearer's body, an intermediate layer containing a loading material, and an outer non-stretch surface with at least one reinforced or stiffened area;
at least one electro-dynamic or electro-mechanic vibration unit, located between an intermediate layer and an outer surface's reinforced area(s);
at least one heating pad unit, including a heating pad connecting jack, located between an inner surface and an outer surface;
a pump allowing an inner surface of an apparatus to fit a wearer's body contour;
a control unit including a control circuit housed within a control housing, a control circuit being in electrical connection with a control unit power input plug connectable to a power source; a vibration frequency and amplitude variable position control switch, a heating pad on/off switch, a heating pad heat intensity variable position heat control switch, and a wiring harness including at least a cable in connection between the control circuit and a vibration unit; a pump and a pump control switch used to fit the apparatus to a wearer's chest.

2. The apparatus of claim 1 wherein:
a lung is induced to vibrate at, or near, a resonance frequency.

3. The apparatus of claim 1, wherein:
said system further includes a battery pack with a battery pack control unit connecting jack; and
said control unit power input plug is connectable with said battery pack control unit connecting jack.

4. The apparatus of claim 3 wherein:
said system further includes an AC/DC converter unit with a converter unit control unit jack; and
said control unit power input plug is connectable to said converter unit control unit jack.

5. The apparatus of claim 4 wherein:
said system further includes a vehicle cigarette lighter power adapter with an adapter control unit connecting jack; and
said control unit power input plug is connectable with said adapter control unit connecting jack.

6. The apparatus of claim 1 wherein:
said intermediate layer is composed of water.

7. The apparatus of claim 1 wherein:
said intermediate layer is composed of a gel with comparable acoustic impedance to water.

8. The apparatus of claim 1 wherein:
said intermediate layer is composed of a layer of water and a layer of a gel with comparable acoustic impedance to water.

9. The apparatus of claim 6 wherein:
a pump is used to displace water to insure the fit of the inner layer to a wearer's chest.

10. The apparatus of claim 8 wherein:
a pump is used to displace a layer of water and of a gel with comparable acoustic impedance to water to insure a fit of an inner layer to a wearer's chest.

11. The apparatus of claim 1 wherein:
said intermediate layer's mass distribution is used to load a lung uniformly.

12. The apparatus of claim 1 wherein:
said intermediate layer's mass distribution produces a load which simulates a user being submerged in water.

13. The apparatus of claim 1 wherein:
said outer layer holds hook and pile fasteners or elastomeric bands to fit an apparatus to a wearer's chest.

14. The apparatus of claim 1 wherein:
a control unit includes a microprocessor.

15. The apparatus of claim 14 wherein:
a microprocessor controls a vibration frequency and amplitude of a vibration unit(s).

16. The apparatus of claim 15 wherein:
a vibration frequency is varied between 10 and 100 Hz to determine a lung resonance frequency.

17. The apparatus of claim 16 wherein:
at least one hydrophone is placed on an inner layer of an apparatus and measures a local sound pressure level.

18. The apparatus of claim 17 wherein:
a hydrophone(s) and microprocessor are used to determine a lung resonance frequency between 10 and 100 Hz.

19. The apparatus of claim 18 wherein:
a microprocessor controls a vibration amplitude of a vibrating unit at a measured resonance frequency for a wearer defined length of time or for a factory defined length of time.

20. The apparatus of claim 14 wherein:
a microprocessor controls a vibration amplitude at a specified percent of a measured resonance frequency or at an increment relative to a wearer's resonance frequency.

21. The apparatus of claim 14 wherein:
an airflow meter is connected to a control unit.

22. The apparatus of claim 21 wherein:
an airflow meter is used to determine a lung resonance frequency.

23. The apparatus of claim 22 wherein:
a microprocessor controls a vibration amplitude of a vibrating unit at a measured resonance frequency for a wearer defined length of time or for a factory defined length of time.

24. The apparatus of claim 23 wherein:
a microprocessor controls the vibration amplitude at a specified percent of a measured resonance frequency or at an increment relative to a wearer's resonance frequency for a wearer defined length of time or for a factory defined length of time.

25. The apparatus of claim 14 wherein:
at least one accelerometer is connected to a control unit.

26. The apparatus of claim 25 wherein:
an accelerometer(s) is (are) used to determine a lung resonance frequency.

27. The apparatus of claim 26 wherein:
a microprocessor controls a vibration amplitude of a vibrating unit at a measured resonance frequency for a wearer defined length of time or for a factory defined length of time.

28. The apparatus of claim 27 wherein:
a microprocessor controls a vibration amplitude at a specified percent of a measured resonance frequency or at an increment relative to a wearer's resonance frequency for a wearer defined length of time or for a factory defined length of time.
